(19) United States
(12) Patent Application Publication
(10) Pub. No.: US 2026/0019804 A1
(43) Pub. Date: Jan. 15, 2026

(54) PRIVACY-PROTECTED ASSOCIATION IDENTIFIERS

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Federico LOVISON, Fontanelle (IT); Javier I. CONTRERAS ALBESA, Sant Cugat del Valles (ES); Jerome HENRY, Pittsboro, NC (US)

(21) Appl. No.: 19/264,638

(22) Filed: Jul. 9, 2025

Related U.S. Application Data
(60) Provisional application No. 63/669,587, filed on Jul. 10, 2024.

(51) Int. Cl. H04W 12/02; H04W 12/50

(52) U.S. Cl. CPC H04W 12/02; H04W 12/50

(57) ABSTRACT

Aspects of this disclosure provide a method including establishing a wireless communications link between an access point and a wireless station. Establishing the wireless communications link comprises assigning the wireless station to an Enhanced Data Privacy (EDP) group that is associated with timing information for rotating wireless frame anonymization parameters at epoch transitions. The method further includes determining a privacy-enhanced association identifier (peAID) having a size greater than a size of an AID field that is used in one or more types of wireless frames on the wireless communications link. The method further includes generating an over-the-air AID (otaAID) to be used in the one or more types of wireless frames. Generating the otaAID comprises applying at least the peAID to a hash function. The method further includes transmitting, from the access point, a first wireless frame having the otaAID in the AID field.

### CROSS-REFERENCE TO RELATED APPLICATIONS

This application claims benefit of co-pending U.S. provisional patent application Ser. No. 63/669,587 filed Jul. 10, 2024. The aforementioned related patent application is herein incorporated by reference in its entirety.

### TECHNICAL FIELD

Embodiments presented in this disclosure generally relate to wireless communication. More specifically, embodiments disclosed herein relate to the generation and assignment of association identifiers (AIDs) in enhanced data privacy (EDP) operations.

### BACKGROUND

Wireless communication networks, such as Wi-Fi, rely on various identifiers to manage device activities and facilitate communication between access points (APs) and wireless stations (STAs). However, the reuse of these identifiers can be exploited to track devices, monitor user activity, and conduct privacy-invasive operations. By collecting and analyzing these identifiers over time, a device's current network activity may be linked to its past network activity. Attackers can collect and analyze these identifiers over time, correlating a device's previous network activity with its present network activity. Some examples of identifiers that are susceptible to being tracked include media access control (MAC) addresses, association identifiers (AIDs), and sequence numbers in frame headers.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example AID Assignment frame including a privacy-enhanced AID generated by an AP, according to some embodiments of the present disclosure.

FIG. 2 depicts an example method for an AP to communicate with a STA using a privacy-enhanced AID, according to some embodiments of the present disclosure.

FIG. 3 depicts an example method for a STA to communicate with an AP using a privacy-enhanced AID, according to some embodiments of the present disclosure.

FIG. 4 depicts an example AID Assignment frame for determining a privacy-enhanced AID, according to some embodiments of the present disclosure.

FIG. 5 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method including establishing a wireless communications link between an access point and a wireless station. Establishing the wireless communications link comprises assigning the wireless station to an Enhanced Data Privacy (EDP) group. The EDP group is associated with timing information for rotating wireless frame anonymization parameters at epoch transitions. The method further includes determining a privacy-enhanced association identifier (peAID) corresponding to the pairing of the access point and the wireless station. A size of the peAID is greater than a size of an AID field that is used in one or more types of wireless frames on the wireless communications link. The method further includes generating an over-the-air AID (otaAID) to be used in the one or more types of wireless frames. Generating the otaAID comprises applying at least the peAID to a hash function. The method further includes transmitting, from the access point, a first wireless frame having the otaAID in the AID field.

Another embodiment presented in this disclosure provides an access point including one or more processors, and memory configured to store computer-readable program code which, when executed by any combination of the one or more processors, performs an operation that includes establishing a wireless communications link with a wireless station. Establishing the wireless communications link includes assigning the wireless station to an Enhanced Data Privacy (EDP) group. The EDP group is associated with timing information for rotating wireless frame anonymization parameters at epoch transitions. The operation further includes determining a privacy-enhanced association identifier (peAID) corresponding to the pairing of the access point and the wireless station. A size of the peAID is greater than a size of an AID field that is used in one or more types of wireless frames on the wireless communications link. The operation further includes generating an over-the-air AID (otaAID) to be used in the one or more types of wireless frames. Generating the otaAID comprises applying at least the peAID to a hash function. The operation further includes transmitting a first wireless frame having the otaAID in the AID field.

Another embodiment presented in this disclosure provides a method for use with a wireless station, the method including establishing a wireless communications link with an access point. The wireless station is assigned to an Enhanced Data Privacy (EDP) group. The EDP group is associated with timing information for rotating wireless frame anonymization parameters at epoch transitions. The method further includes determining a privacy-enhanced association identifier (peAID) corresponding to the pairing of the access point and the wireless station. A size of the peAID is greater than a size of an AID field that is used in one or more types of wireless frames on the wireless communications link. The method further includes generating an over-the-air AID (otaAID) to be used in the one or more types of wireless frames. Generating the otaAID comprises applying at least the peAID to a hash function. The method further includes receiving a first wireless frame from the access point, and determining whether the first wireless frame is intended for the wireless station. Determining whether the first wireless frame is intended for the wireless station includes applying a value of the AID field of the first wireless frame to the hash function, and determining whether the result of applying the value of the AID field matches the peAID.

### Example Embodiments

Enhanced Data Privacy (EDP) has been introduced to prevent attackers from tracking devices based on fixed identifiers commonly used in wireless communication networks. EDP involves dynamically updating identifiers at defined epochs to anonymize the device's identity. Such periodic changes improve privacy by making it difficult for an attacker to correlate a device's presence and activity across different time intervals.

Common identifiers that are susceptible to being tracked include the MAC address, AID, sequence numbers in frame headers, and other protocol-specific identifiers that are used across multiple transmissions. Among these, the AID tends to be one of the most easily trackable identifiers. The AID is typically assigned to a wireless station (STA) during the association phrase with a Basic Service Set Identifier (BSSID) and is used across various functionalities, including preamble encoding, delivery traffic indication map (DTIM) information, power saving (PS)-poll, and very high throughput (VHT) transmission opportunity (TXOP) for power-saving clients. Additionally, AID values are utilized in several other protocol-specific mechanisms within IEEE 802.11 networks, further increasing their exposure.

The AID is particularly vulnerable to tracking for two main reasons. First, AID values are transmitted in the clear (e.g., in an unencrypted format) within various 802.11headers and payloads, making them easily observable by third parties. Since these identifiers are not encrypted, an attacker can passively monitor wireless traffic and extract AID values without requiring active participation in the network. Second, AID values are assigned from a relatively limited pool of values, typically represented in 11 bits (around 2000 values), with some protocol-specific scenarios allowing 12-bit or 13-bit AIDs. Even with the largest AID size, the total pool of possible AID values remains small compared to a random MAC address space, which can be up to 46 bits (out of a 48-bit MAC address space). This limited address space makes it feasible for attackers to correlate AIDs across different frames and track devices over time.

Frames and procedures used in EDP are being defined in IEEE 802.11bi to improve station privacy and prevent device tracking based on persistent identifiers. One potential approach involves updating parameters such as the MAC address and AID at defined time intervals, referred to as “epochs.” However, were the same AID used consistently across different epochs, an adversary could correlate these addresses and enables long-term tracking of the device. Such correlation defeats the privacy objectives of IEEE 802.11bi and similar wireless standards.

To enhance privacy while maintaining network efficiency, the AID assignment mechanism for IEEE 802.11bi (or another wireless standard) may meet several criteria. First, an AID value should not be used consistently by the same STA across two consecutive epochs, as this would enable an adversary to link identifiers and correlate the device's network activity, even when MAC randomization is applied. Second, STAs associated with a single BSSID should not be able to predict the AID value that another STA in the same BSSID will use in the next epoch. This is to prevent internal privacy risks where a device could infer another device's future AID assignment. Third, there should be no AID collisions among STAs within a BSSID, as such collisions can negatively impact network performance and power-saving mechanisms. Fourth, AID assignment should be time-deterministic, where the time required to determine the AIDs remains fixed and does not introduce variations (which could otherwise disrupt traffic flow). Finally, AID assignment should maintain backward compatibility, allowing legacy devices to coexist in the same channel, where AIDs are typically assigned from an 11-bit space (e.g., approximately 2000 values).

Embodiments of the present disclosure provide systems, methods, and apparatuses for AID generation and assignment that satisfy some or all of these five privacy criteria and enable efficient AID management in EDP. In some embodiments, the AP manages AID assignment to connected STAs in the same BSSID. In other embodiments, the AP coordinates with the STA to determine the assigned AID.

In various embodiments, a privacy-enhanced AID (also referred to as a “peAID”) is determined with a size that is larger than the size of the AID field, and in some cases may be significantly larger (e.g., 48 bits>>11 bits). The peAID may be determined by the AP and shared in a protected communication with the STA (e.g., within an AID assignment frame), or the peAID may be separately determined by the AP and the STA using a predetermined, shared algorithm. The protected communication between the AP and the STA may be achieved through any suitable techniques. For example, a frame containing the peAID (or indicating one or more values for determining the peAID) may be encrypted using keys exchanged during authentication (e.g., as with data frames) or according to techniques used for protecting management frames (e.g., 802.11w). Because the pool of values using the peAID is correspondingly greater than the typical range of AID values (e.g., 2⁴⁸>>2000), there is a much lower chance of correlating the AID values across epochs. In some embodiments, the peAID is applied to a hash function to generate an over-the-air AID (also referred to as a “otaAID”) that is included in the AID field of wireless frames. The AP and the STA are able to extract the peAID from the received otaAID to determine the correct sender and/or recipient.

In some embodiments, the peAID is changed at predetermined intervals (e.g., after the elapse of N epochs), to reduce the likelihood of correlation. To further reduce the likelihood, where N>1, a salt value can be updated at each epoch and applied to the hash function, such that the otaAID also changes at each epoch.

In those embodiments where the AP manages AID assignment, the AP in its centralized role distributes the peAIDs among connected STAs in the same BSSID. In this embodiment, the AP may directly select the peAIDs for each STA from the available pool according to various privacy criteria. Since the AP is aware of the peAIDs assigned to each STA, as well as the hash functions that are used to generate the otaAIDs, the AP can predict or detect otaAID collisions that may arise during a particular epoch. Additionally, since the AP has full control over peAID assignment, STAs have no visibility into the allocation process and cannot predict the peAIDs (or otaAIDs) that are assigned to other STAs in the same BSSID.

In other embodiments where the AP coordinates with the STA to determine the assigned AID, the AP and the STA each derive the peAID values using a predetermined algorithm, such as a pseudorandom function that produces an output of a particular length, such as PRF-128, PRF-64, and so forth. In some embodiments, the AP may indicate the predetermined algorithm and/or one or more parameters for the algorithm to the STA using a protected communication such as an AID assignment frame. This approach provides several advantages. First, otaAID collisions are unlikely due to the length of the peAID, and can readily be predicted or detected by the AP due to the shared algorithm and hash functions. Second, a STA cannot predict another STA's otaAID, preventing internal privacy risks. Third, brute-force attacks are mitigated because the input domain may be significantly larger than the otaAID output range, making it infeasible for an attacker to precompute mappings. Finally, this approach improves security by eliminating the need to transmit AID lists over the air.

In some embodiments, the assigned peAIDs or hash function parameters may be transmitted to the STA using an AID assignment frame. The AID assignment frame may be implemented as a separate action frame or as part of an extensible authentication protocol over local area network (LAN) (EAPOL) message 4 during the 4-way handshake process. In some embodiments, the AID assignment frame is proactively transmitted by the AP to all connected STAs. In some embodiments, the AID assignment frame is sent in response to a request from an STA.

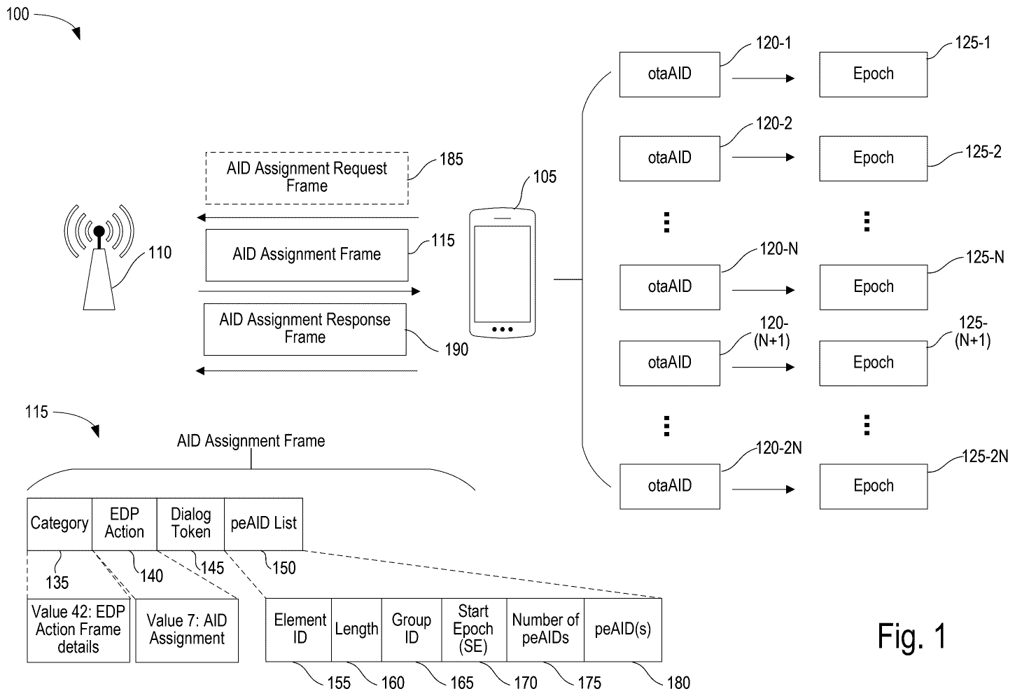

FIG. 1 depicts an example AID assignment frame 115 including a privacy-enhanced AID (peAID) generated by an AP 110, according to some embodiments of the present disclosure. As depicted, the AP 110 transmits an AID assignment frame 115 to a connected STA 105. The AP 110 may refer to an AP multi-link device (MLD), a single-link AP, or any other type of wireless network device capable of managing AID assignment within a BSSID. The STA 105 may refer to a non-AP MLD, a single-link device, or another type of wireless station capable of establishing a connection with the AP 110.

As shown in FIG. 1, the AID assignment frame 115 may be transmitted proactively or reactively. In a proactive transmission, the AP 110 sends the AID assignment frame 115 without first receiving an AID assignment request 185 from the STA 105. This approach reduces latency and minimizes unnecessary signaling. In another embodiment, in a reactive transmission, the AP 110 may send the AID assignment frame 115 in response to an AID assignment request 185 from the STA 105. Within the AID assignment request 185, the STA 105 may include information such as association status, storage limit, preferred update timing, and any other constraints to AID assignment.

In some embodiments, the AID assignment frame 115 is implemented as a separate action frame or as part of an extensible authentication protocol over local area network (LAN) (EAPOL) message 4 during the 4-way handshake process.

The AID assignment frame 115, as depicted, includes one or more peAID values 180 that are generated by the AP 110 and each of which are assigned to the STA 105 for use during N subsequent epochs (e.g., epochs 125-1, . . . , 125-N), where N is an integer greater than 1. The peAID value(s) 180 have a size that is larger than the size of the AID field, and in some cases may be significantly larger. In some embodiments, the peAID value(s) 180 are at least twice as large as the AID field (e.g., typically 11 bits). Some non-limiting examples of the peAID value(s) 180 may have lengths of 16 bits, 32 bits, 48 bits, 64 bits, 128 bits, and so forth. The peAID value(s) 180 may be generated using any suitable techniques. For example, the AP 110 may use a pseudorandom function that produces an output of a particular length, such as a PRF-128, PRF-64, and so forth. In other examples, the AP 110 may derive the peAID value(s) 180 using one or more values associated with the AP 110 and/or the STA 105, such as identifiers or other parameters of the wireless communications link between the AP 100 and the STA 105, to generate the peAID value(s) 180. Other processing may be performed when generating the peAID value(s) 180. For example, in accordance with the discussion below, the AP 110 may determine which over-the-air AID (otaAID) values are currently available, and which of the available otaAID values might be considered predictable for the STA 105 (e.g., consecutive to the previous otaAID value for the STA 105). The AP 110 may then select one or more of the available, less-predictable otaAID values and generate the peAID value(s) 180 that will produce the one or more otaAID values.

Pre-assignment of the peAID value(s) 180 reduces signaling overhead, as the STA 105 does not need to request and/or await a new peAID value 180 at each epoch. In some embodiments, the AP 110 may transmit multiple peAID values 180 to be used for subsequent groups of epochs (e.g., for epoch 125-(N+1) and beyond). The multiple peAID values 180 may be represented in a list, or as one or more offset values used to transition from one peAID value 180 to the next.

As shown, a first peAID value 180 is assigned to epochs 125-1, 125-2, . . . , 125-N, and a second peAID value 180 is assigned to epochs 125-(N+1), . . . , 125-2N. In other implementations, the groups of epochs may have different lengths (e.g., at least one group of epochs has a length other than N).

The AID assignment frame 115 includes several fields that facilitate structured AID allocation. These fields include a Category field 135, an EDP Action field 140, a Dialog Token field 145, and a peAID List element 150. The Category field 135 specifies the frame category. For an EDP action frame, a predefined value of 42 is included within the field to differentiate it from other types of action frames (e.g., Protected High Throughput (HT) Action frame, Protected Very High Throughput (VHT) Action frame). The EDP Action field 140 specifies the type of EDP action being performed. For AID assignment, this field is set to 7, distinguishing it from other EDP-related actions (e.g., EDP Group Parameter frames, EDP Epoch Request frames, EDP Epoch Response frames). The Dialog Token field 145 is set to a nonzero value to track request/response transactions between the AP 110 and STA 105. The peAID List element 150 contains one or more peAID values 180 that are assigned to the STA 105 for use in the next groups of EDP epochs.

Within the peAID List element 150, the following subfields are included: an Element ID field 155, a Length field 160, a Group ID field 165, a Start Epoch (SE) field 170, a Number of peAIDs field 175, and a field storing the one or more peAID values 180. The Element ID field 155 includes values that identify the peAID List element 150 within the AID Assignment frame 115. The Length field 160 specifies the total length of the peAID List element 150. The Group ID field 165 indicates the EDP group to which the STA 105 belongs. As used herein, an EDP group includes a set of STAs 105 that follow a common AID update policy. Within the group, each STA 105 updates the AIDs periodically at predefined intervals to prevent long-term tracking. The AP 110 may advertise available EDP groups to connected STAs 105. Each available EDP may have specific epoch intervals and/or minimum storage requirements. A group with a larger epoch interval (e.g., 1 day) may have a lower storage size requirement, as longer intervals require few AID updates within the same period of time, reducing the total number of AIDs that need to be stored by the STA 105. The STA 105 may evaluate these parameters and send a request to join a suitable EDP group. Once the STA 105 is accepted into an EDP group, the AP 110 may assign peAIDs to the STA 105 for use in upcoming epochs. Within the AID Assignment frame 115, the AP 110 uses the Group ID field 165 to indicate the group that the STA 105 has joined.

The SE field 170 defines the first epoch in which the assigned peAID value(s) 180 take effect. The Number of peAIDs field 175 specifies the total number of the peAID value(s) 180 assigned in the AID assignment frame 115. The remaining field stores the actual peAID value(s) 180 that are assigned to the STA 105 for use in different groups of epochs. Each entry of the field is stored in a fixed-length format and may be ordered sequentially, where each value corresponds to a specific contiguous group of epochs following the SE field 170. For example, the AP 110 may assign two peAID values 180 in a single AID assignment frame 115: a first peAID value 180 that is assigned to epochs 125-1, 125-2, . . . , 125-N, and a second peAID value 180 that is assigned to epochs 125-(N+1), . . . , 125-2N. In this way, each peAID value 180 may be applied in the correct chronological order without requiring the STA 105 to perform additional processing for mapping the peAID value(s) 180 to specific groups of epochs.

Other formatting of the AID assignment frame 115 is also contemplated. For example, the AID assignment frame 115 may include a single peAID value 180 (in which case the Number of peAIDs field 175 may be omitted), may include value(s) indicating the number of epochs for which each peAID value 180 will be used, and so forth.

In some embodiments, upon receiving the AID assignment frame 115, the STA 105 may send an AID assignment response frame 190 to the AP 110 indicating the status of the received peAID value(s) 180. For example, the AID assignment response frame 190 may indicate that the peAID value(s) 180 have been fully stored by the STA 105, partially stored, or rejected by the STA 105 as being sent too early.

In this way, both the AP 110 and the STA 105 possess a same set of peAID value(s) 180. As mentioned above, the peAID value(s) 180 have a size that is larger than the size of the AID field found in various types of wireless frames, such as preamble encoding, DTIM information, PS-poll, and VHT TXOP for power-saving clients. In various embodiments, the peAID value(s) 180 are applied to a hash function to generate one or more over-the-air AID (otaAID) value(s) 120-1, 120-2, . . . , 120-2N that are used by the AP 110 and the STA 105 within the AID fields of the various wireless frames. Generally, the hash function used for generating each of the otaAID value(s) 120-1, 120-2, . . . , 120-2N may be represented as:

$$H ( x ) = ( Ax + B ) mod P$$

where H(x) is the computed otaAID value, A and B are parameters shared by the AP 110 for computation of the otaAID, x is the current peAID value 180, and P is a prime number that bounds H(x) to the valid range of values for the AID field (e.g., 1-2000 in an 11-bit space). Although the current peAID value 180 may be applied for a group of N epochs, in some embodiments, the values of A and/or B may be changed at every epoch 125-1, 125-2, . . . , 125-2N, such that the otaAID value for every epoch 125-1, 125-2, . . . , 125-2N is different. Thus, the parameters A and B may be described as salt values that are also applied to the hash function to ensure that the STA 105 cannot be tracked across multiple epochs using the otaAID value(s) 120-1, 120-2, . . . 120-2N. Some non-limiting examples of salt values include an epoch number, a discriminator value, and so forth.

The AP 110 and the STA 105 subsequently communicate wireless frames having one of the otaAID value(s) 120-1, 120-2, . . . , 120-2N in the AID field. As the recipient of the wireless frames also possesses the hash function and the peAID value(s) 180 (and optionally the salt values), the recipient is capable of determining whether the output of the hash function matches the received otaAID value(s) 120-1, 120-2, . . . , 120-2N. The AP 110 and/or the STA 105 may have the comparison value calculated and prestored (e.g., the otaAID value(s) that are used for comparison with the received otaAID value(s) 120-1, 120-2, . . . , 120-2N are calculated responsive to determining the peAID value 180).

When a match is determined for a particular peAID value 180, the recipient may then attempt to decrypt the wireless frame using keys exchanged during the association process with the corresponding STA 105. In most cases, a single STA 105 corresponds to the received otaAID value 120-1, 120-2, . . . , 120-2N. In other cases, the hash function may map multiple peAID values 180 onto a same otaAID value, such that the recipient determines multiple matches for a received otaAID value 120-1, 120-2, . . . , 120-2N. When the AP 110 is the recipient, the AP 110 may determine which STA 105 transmitted the wireless frame based on whether decryption was successful. When the STA 105 is the recipient, the STA 105 may determine whether it is the intended recipient of the wireless frame based on whether decryption was successful.

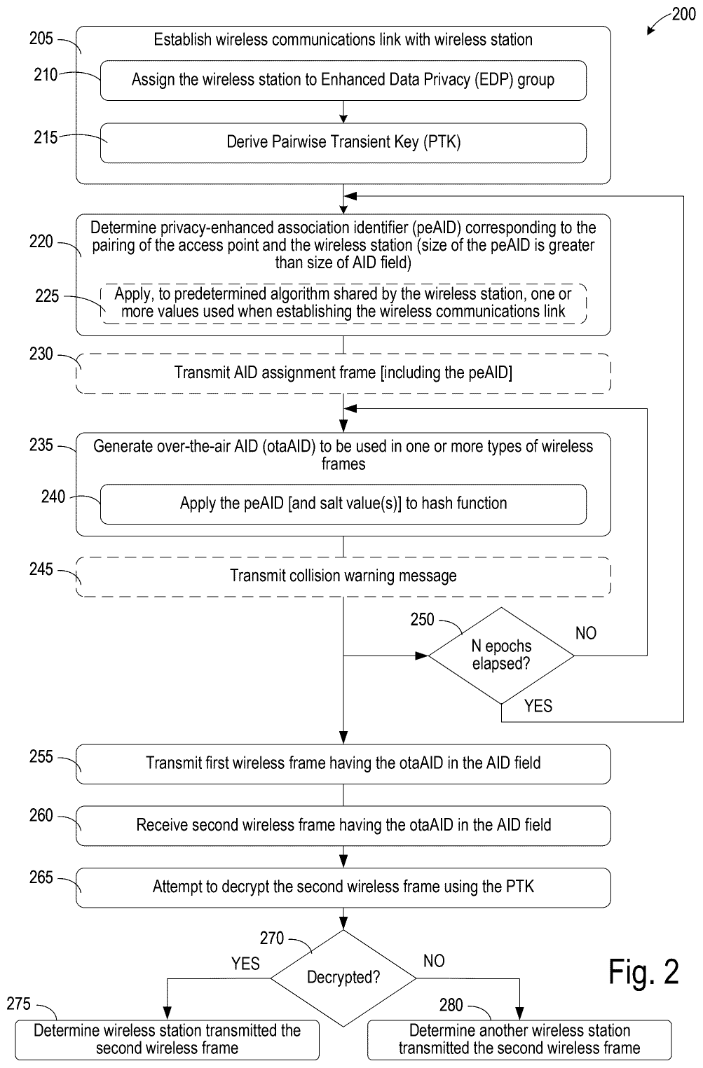

FIG. 2 depicts an example method 200 for an AP to communicate with a STA using a peAID, according to some embodiments of the present disclosure. The method 200 may be used in conjunction with other embodiments, such as being performed by the AP 110 of FIG. 1.

The method 200 begins at block 205, where the AP establishes a wireless communications link with a wireless station (such as the STA 105), which in some cases encompasses an authentication process and an association exchange process between the AP 110 and the STA 105. In some embodiments, establishing the wireless communications link comprises, at block 210, assigning the wireless station to an EDP group that is associated with timing information for rotating wireless frame anonymization parameters at epoch transitions. In some embodiments, establishing the wireless communications link further comprises, at block 215, deriving a Pairwise Transient Key (PTK). Generally, the PTK may be derived from a Pairwise Master Key (PMK) that is established during the authentication process, and may include using random nonces and/or other values from the AP 110 and the STA 105 as part of a four-way handshake process.

At block 220, the AP 110 determines a peAID corresponding to the pairing (e.g., the combination) of the AP 110 and the STA 105. The size of the peAID is greater than the size of an AID field used in wireless frames. The peAID may be determined using any suitable techniques. In some embodiments, the AP 110 may use a pseudorandom function to produce a peAID value of a predetermined length. In other embodiments, the peAID may be derived using value(s) associated with the AP 110 and/or the STA 105, such as identifiers or other parameters of the wireless communications link.

In some embodiments, determining the peAID comprises, at an optional block 225, applying one or more values used when establishing the wireless communications link to a predetermined algorithm that is shared by the wireless station. For example, the AP 110 and the STA 105 may each store the same predetermined algorithm (e.g., a pseudorandom function), and the AP 110 indicates which algorithm to use and/or values of one or more parameters to be applied to the algorithm, such that the AP 110 and the STA 105 may derive the same peAID value independently. In some embodiments, the AP 110 uses one or more values that are used when establishing the wireless communications link, such as a MAC address of the STA 105, a MAC address of the AP 110, an Authenticator Nonce generated by the AP 110, and a Supplicant Nonce generated by the STA 105.

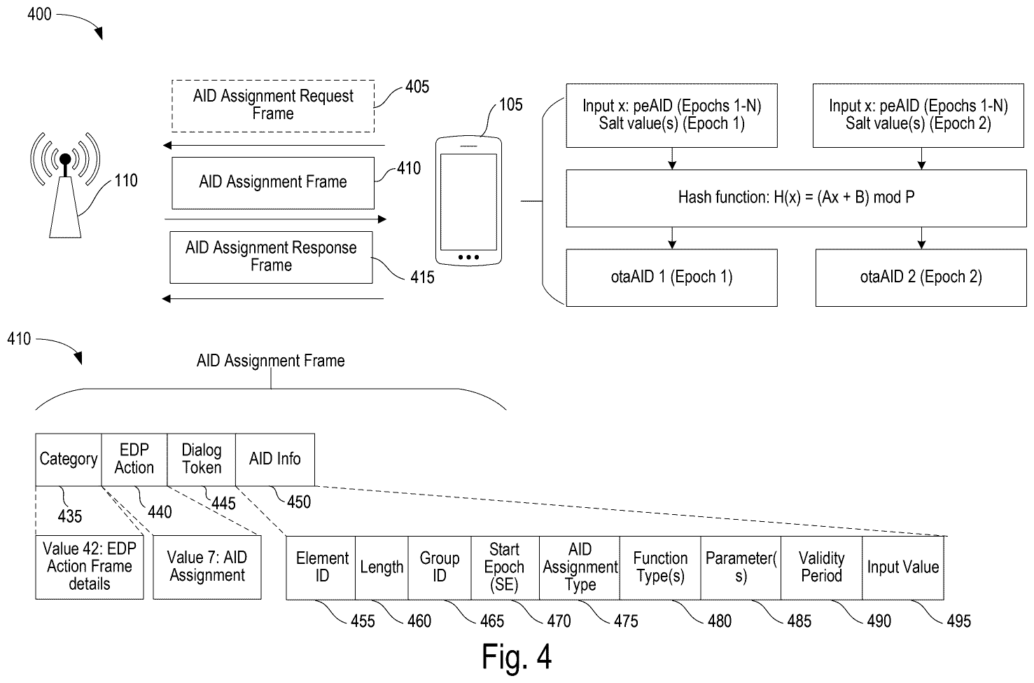

At an optional block 230, the AP 110 transmits an AID assignment frame to the STA 105. Some non-limiting examples of the AID assignment frame are provided in FIG. 1 and in FIG. 4. In some embodiments, the AID assignment frame includes one or more values of the peAID. In other embodiments, the AID assignment frame includes one or more values used by the STA 105 to derive the peAID.

At block 235, the AP 110 generates an otaAID to be used in one or more types of wireless frames. Some examples of the types of wireless frames include management frames (e.g., an association response frame or beacon frame) and control frames (e.g., a PS-Poll frame). In some embodiments, generating the otaAID comprises, at block 240, applying the peAID (and optionally one or more salt values) to a hash function. Generally, the hash function bounds the otaAID to the valid range of values for the AID field of the wireless frames.

It is contemplated that the AP 110 may also connect to one or more legacy STAs that are not compatible with the techniques for EDP communications using the peAID and otaAID described herein. In some embodiments, the otaAID assignment space may be partitioned into a first domain for legacy (or incompatible) STAs and a second domain for compatible STAs. In one non-limiting example, a most significant bit (MSB) of the determined otaAID is reserved as an indicator of the domain for the STA (e.g., a MSB of zero indicates the first domain, and a MSB of one indicates the second domain).

At an optional block 245, the AP 110 transmits a collision warning message to the STA 105 and/or one or more other STAs. In some embodiments, transmitting the collision warning message is responsive to the AP 110 determining that the generated otaAID corresponds to the STA 105 and/or the one or more other STAs. The collision warning message may be included in a protected communication. In some embodiments, the collision warning message may also provide one or more values for generating a new peAID for the STA 105, such as a replacement value of the peAID and/or one or more new values of the parameter(s) for the hash function. For example, the AP 110 may generate a new salt value such as a discriminator, a BSS color of the STA 105, a combination of the NDP Feedback Report Poll (NFRP) and uplink orthogonal frequency division multiple random access (UORA), and so forth. The AP 110 may guarantee that the replacement value and/or the new values of the parameter(s) will be collision-free during the current or next epoch.

Flow proceeds to block 250, where the AP 110 determines whether N epochs have elapsed for the current peAID value, where N is an integer greater than 1. In some embodiments, this determination occurs at the transition between each epoch and the next. If N epochs have not elapsed (“NO”), the peAID value is still considered valid and flow returns to block 235, where a next value of the otaAID is generated (e.g., applying the peAID and an updated salt value to the hash function). After N epochs have elapsed (“YES”), the peAID value is no longer valid and flow returns to block 220, where the AP 110 and/or STA 105 determine a next value of the peAID.

Regardless of the current values of the peAID and otaAID, after generating the otaAID at block 235, flow may proceed to block 255, where the AP 110 transmits a first wireless frame having the otaAID in the AID field. At block 260, the AP 110 receives a second wireless frame having the otaAID in the AID field. At block 265, the AP 110 attempts to decrypt the second wireless frame using the PTK corresponding to the STA 105 and derived at block 215. If decryption is successful at block 270 (“YES”), flow proceeds to block 275 and the AP 110 determines that the STA 105 transmitted the second wireless frame. If the decryption is not successful (“NO”), flow proceeds to block 280 and the AP 110 determines that another wireless station transmitted the second wireless frame.

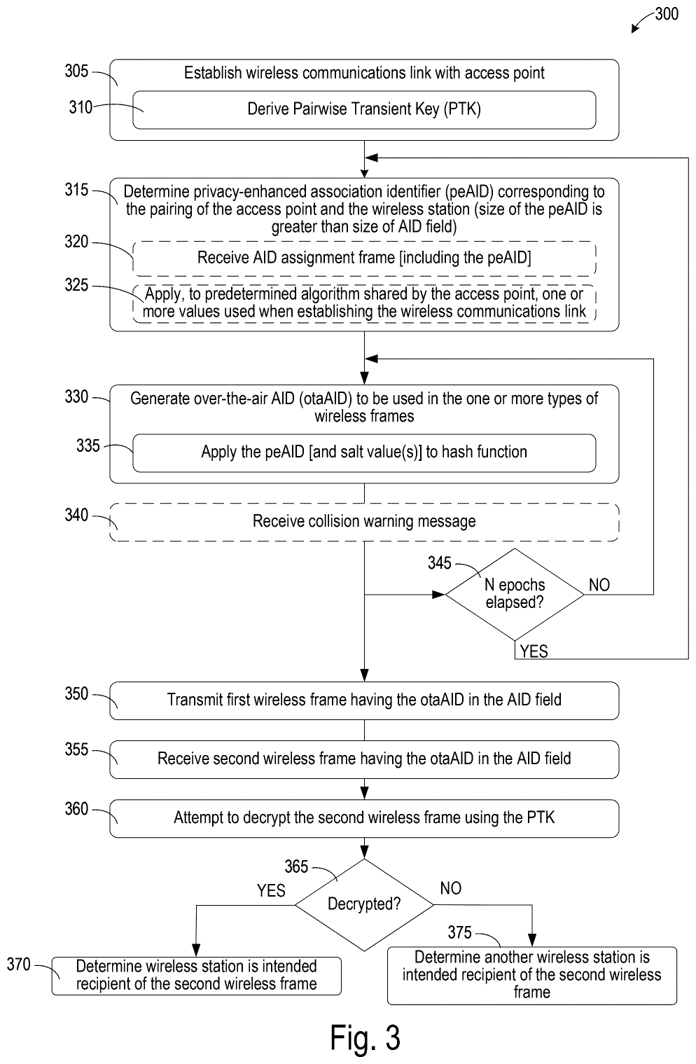

FIG. 3 depicts an example method 300 for a STA to communicate with an AP using a privacy-enhanced AID, according to some embodiments of the present disclosure. The method 300 may be used in conjunction with other embodiments, such as being performed by the STA 105 of FIG. 1.

The method 300 begins at block 305, where the STA 105 establishes a wireless communications link with an AP (such as the AP 110), which in some cases encompasses an authentication process and an association exchange process and may be the counterpart to block 205 performed by the AP 110. In some embodiments, establishing the wireless communications link comprises, at block 310, deriving a Pairwise Transient Key (PTK), which may be the counterpart to block 215 performed by the AP 110, e.g., as part of a four-way handshake process.

At block 315, the STA 105 determines a peAID corresponding to the pairing of the AP 110 and the STA 105. The size of the peAID is greater than the size of an AID field used in wireless frames.

At an optional block 320, the STA 105 receives an AID assignment frame from the AP 110, which may be the counterpart to optional block 230 performed by the AP 110. In some embodiments, the AID assignment frame includes one or more values of the peAID. In other embodiments, the AID assignment frame includes one or more values used by the STA 105 to derive the peAID.

At an optional block 325, the STA 105 applies, to a predetermined algorithm that is shared by the AP 110, one or more values that are used when establishing the wireless communications link. Some examples of the one or more values include a MAC address of the STA 105, a MAC address of the AP 110, an Authenticator Nonce generated by the AP 110, and a Supplicant Nonce generated by the STA 105.

At block 330, the STA 105 generates an otaAID to be used in one or more types of wireless frames. In some embodiments, generating the otaAID comprises, at block 335, applying the peAID (and optionally one or more salt values) to a hash function. Generally, the hash function bounds the otaAID to the valid range of values for the AID field of the wireless frames.

At an optional block 340, the STA 105 receives a collision warning message from the AP 110, which may be the counterpart to block 245 performed by the AP 110. In some embodiments, the collision warning message may also provide one or more values for the STA 105 to generate a new peAID, such as a replacement value of the peAID and/or one or more new values of the parameter(s) for the hash function.

Flow proceeds to block 345, where the STA 105 determines whether N epochs have elapsed for the current peAID value, where N is an integer greater than 1. In some embodiments, this determination occurs at the transition between each epoch and the next. If N epochs have not elapsed (“NO”), the peAID value is still considered valid and flow returns to block 330, where a next value of the otaAID is generated (e.g., applying the peAID and an updated salt value to the hash function). After N epochs have elapsed (“YES”), the peAID value is no longer valid and flow returns to block 315, where the STA 105 determines a next value of the peAID.

Regardless of the current values of the peAID and otaAID, after generating the otaAID at block 330, flow may proceed to block 350, where the STA 105 transmits a first wireless frame having the otaAID in the AID field. At block 355, the STA 105 receives a second wireless frame having the otaAID in the AID field. The STA 105 determines whether the second wireless frame is intended for the STA 105. In some embodiments, determining whether the second wireless frame is intended for the STA 105 comprises applying a value of the AID field of the second wireless frame (e.g., the otaAID value) to the hash function stored by the STA 105, and determining whether the result of applying the value of the AID field matches the peAID. In some embodiments, determining whether the second wireless frame is intended for the STA 105 (further) comprises, at block 360, the attempting to decrypt the second wireless frame using the PTK corresponding to the AP 110 and derived at block 310. If decryption is successful at block 365 (“YES”), flow proceeds to block 370 and the STA 105 determines that it is the intended recipient of the second wireless frame. If the decryption is not successful (“NO”), flow proceeds to block 375 and the STA 105 determines that another wireless station is the intended recipient of the second wireless frame.

FIG. 4 depicts an example AID assignment frame 410 for determining a privacy-enhanced AID, according to some embodiments of the present disclosure. More specifically, FIG. 4 provides an alternate implementation in which the AID assignment frame 410 includes various parameters that enable the STA 105 to calculate peAIDs and/or otaAIDs.

Instead of sending pre-generated peAIDs in the AID assignment frame 115 of FIG. 1, in FIG. 4 the AP 110 transmits to the STA 105 one or more types of function(s) to be used to generate the peAID (e.g., a pseudorandom function) and/or the otaAID (e.g., a hash function), and relevant parameters for the function(s). Using these function(s) and parameters, each STA 105 is enabled to dynamically generate the peAID and/or the otaAID locally without direct exposure of the peAID and otaAID values over the air.

As discussed above, the hash function used for generating each of the otaAID value(s) 120-1, 120-2, . . . , 120-2N may be represented as:

$$H ( x ) = ( Ax + B ) mod P$$

where H(x) is the otaAID value computed by the STA 105, A and B are parameters that may be included in the AID assignment frame 410, x is the current peAID value 180 transmitted in the AID assignment frame 410 or computed by the STA 105, and P is a prime number that bounds H(x) to the valid range of values for the AID field (e.g., 1-2000 in an 11-bit space).

Whether transmitted by the AP 110 or computed by the STA 105, the current peAID value 180 may be applied for a group of N epochs. In some embodiments, the values of the parameters A and/or B may be changed at every epoch 125-1, 125-2, . . . , 125-2N, such that the otaAID value for every epoch 125-1, 125-2, . . . , 125-2N is different. As shown, for a first epoch (Epoch 1), the input x is the current peAID value 180 applied for Epochs 1−N, and the parameters A and/or B are applied as salt values particular to Epoch 1. The values of x, A, B are applied to the hash function to generate an otaAID 1 for use during Epoch 1. For a second epoch (Epoch 2), the input x remains the current peAID value 180 applied for Epochs 1−N, and the parameters A and/or B are updated for Epoch 2. The values of x, A, B are again applied to the hash function to generate an otaAID 2 for use during Epoch 2. In this way, a unique otaAID value can be generated for each epoch.

In some embodiments, the AID assignment frame 410 including function(s) and/or parameters, may be sent proactively by the AP 110. The AP 110 may periodically broadcast (or unicast) the AID assignment frame 410 to all connected STAs without receiving a request. In some embodiments, the AP 110 may send the AID assignment frame 410 in response to an AID request frame 405 from a specific STA 105. This approach allows STAs 105 to request function(s) and/or parameters when needed and therefore reduces unnecessary transmissions. The reactive approach may be beneficial for power-saving STAs, which may prefer to request updated function(s) and/or parameters only when they wake from sleep mode.

The AID assignment frame 410 may be sent in different formats. In some embodiments, the AID assignment frame 410 may be structured as a separate action frame. In some embodiments, the AP 110 may embed information from the AID assignment frame 410 within Message 4 of the EAPOL handshake process.

Upon receiving the AID assignment frame 410, the STA 105 may send a response frame 415 to AP 110, indicating the status of the received function(s) and/or parameters. In some embodiments, the response frame 415 may confirm that the function(s) and/or parameters were received and properly stored. If the STA 105 detects any inconsistencies or corruption in the received function(s) and/or parameters, the response frame 415 may request a retransmission or correction.

As depicted, the AID assignment frame 410 includes the following fields: a Category field 435, an EDP Action field 440, a Dialog Token field 445, and an AID information element 450. The Category field 435 identifies the frame category, indicating that the AID assignment frame 410 relates to EDP operations (e.g., value 42). The EDP Action field 440 indicates the type of EDP action being requested (e.g., value 7 for AID assignment-related actions). The Dialog Token field 445 is set to a nonzero value to track request and response messages. The AID information element 450 includes the actual AID assignment details, such as the function(s) and/or parameters to be used by the STA 105 to generate values of the peAID and/or the otaAID.

As depicted, the AID information element 450 comprises multiple subfields that provide the details for computing values of peAID and/or otaAID. The Element ID subfield 455 identifies the type of the AID information element 450 within the AID assignment frame 410. The Length subfield 460 indicates the total length of the AID information element 450. The Group ID subfield 465 specifies the EDP group to which the STA 105 belongs. The Start Epoch (SE) subfield 470 indicates the epoch from which the function(s) and/or parameters become valid. This field is to maintain proper synchronization between the AP 110 and the STA 105.

The AID assignment type subfield 475 defines whether the AID assignment follows pre-generated peAID allocation (e.g., as depicted in FIG. 1) or relies on the STA 105 to apply the function(s) and/or parameters to generate the peAID (e.g., as depicted in FIG. 6). The function type(s) subfield 480 indicate to the STA 105 which function(s) are to be applied by the STA 105 to generate the peAID and/or the otaAID, and the values of the function type(s) subfield 480 may be interpreted differently based on the AID assignment type subfield 475 (e.g., whether the STA 105 is expected to generate the peAID). The Parameter(s) subfield 485 contains one or more parameters that are applied to the function(s) specified by the function type(s) subfield 480 required by the STA 105 to compute the peAID and/or otaAID dynamically. For example, the Parameter(s) subfield 485 may include the parameters A, B, P for a hash function that the STA 105 uses to generate an otaAID. The Validity period subfield 490 defines the duration for which the assigned parameters remain valid. Once the validity period expires, the AP 110 may send new values of the parameters to the STA 105 to refresh AID assignment. The Input Value subfield 495 indicates the input that the STA 105 uses for AID computation. In some embodiments, the Input Value subfield 495 includes the peAID value directly. In other embodiments, the Input Value subfield 495 includes one or more other values used by the STA 105 to generate the peAID value, such as a MAC address of the STA 105, a cryptographic nonce, a session key, or any other long-bitstring values.

Thus, the AID assignment frame 410 is designed to support function-based computation of peAIDs and otaAIDs. With the included information (e.g., function(s), parameters, validity periods, and input value), the STA 105 may calculate peAIDs and/or otaAID for subsequent epochs dynamically and independently.

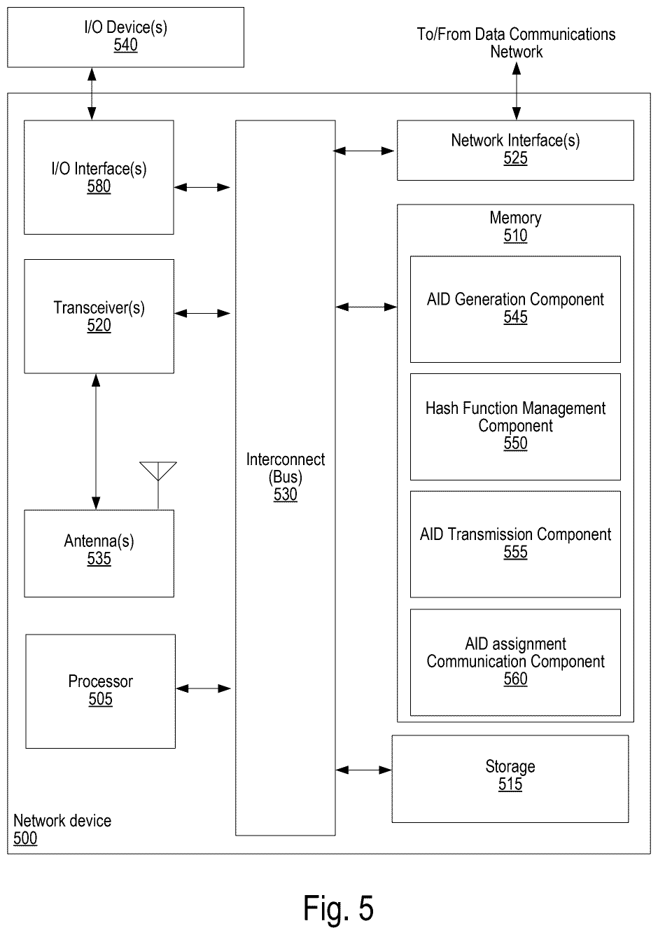

FIG. 5 depicts an example network device 500 configured to perform various aspects of the present disclosure. The network device 500 may represent one example implementation of the AP 110 depicted in FIGS. 1 and 4.

As illustrated, the example network device 500 includes a processor 505, memory 510, storage 515, one or more transceivers 520, one or more I/O interfaces 580, and one or more network interfaces 525. In some embodiments, I/O devices 540 are connected via the I/O interface(s) 580. Further, via the network interface 525, the network device 500 can be communicatively coupled with one or more other devices and components (e.g., via a network, which may include the Internet, local network(s), and the like). Each of the components is communicatively coupled by one or more buses 530. In some embodiments, one or more antennas 535 may be coupled to the transceivers 520 for transmitting and receiving wireless signals.

The processor 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 505 processes information received through the transceiver 520, I/O interfaces 580, and the network interfaces 525. The processor 505 retrieves and executes programming instructions stored in memory 510, as well as stores and retrieves application data residing in storage 515.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system.

The memory 510 may include random access memory (RAM) and read-only memory (ROM). The memory 510 may store processor-executable software code containing instructions that, when executed by the processor 505, enable the network device 500 to perform various functions described herein for wireless communication. In the illustrated example, the memory 510 includes four software components: the AID generation component 545, the hash function management component 550, the AID transmission component 555, and the AID assignment communication component 560.

In one embodiment, the AID generation component 545 is configured to manage the allocation of AIDs (specifically, peAIDs and/or otaAIDs) to connected STAs. In one embodiment, the AID generation component 545 assigns peAIDs directly to STAs. The AID generation component 545, along with the hash function management component 550, may apply a hash function to the various peAIDs to detect and/or prevent collisions of corresponding otaAIDs, issuing a collision warning to affected STAs and assigning new value(s) of the peAIDs to prevent subsequent collisions.

In one embodiment, the hash function management component 550 is configured to generate and manage hash function parameters for otaAID computation by STAs. More specifically, the hash function management component 550 computes STA-specific parameters (e.g., A, B, P) for the hash function, determines validity periods for parameter use, and optionally specifies high-entropy inputs (e.g., OTA MAC address, session key) used in the hash function.

In one embodiment, the AID transmission component 555 is configured to determine how AID-related information is transmitted to STAs, including frame construction, transmission policy, and sharing format (e.g., full list encoding or delta encoding). When peAIDs are generated and assigned directly by the network device 500, the AID transmission component 555 selects the sharing format based on network conditions and STA processing capability. The two sharing formats include full list encoding (transmitting all peAIDs at once) and delta encoding (transmitting an initial peAID with incremental updates). Upon determining the format, the AID transmission component 555 constructs the AID Assignment frame to include the peAID list, epoch information, and metadata specifying the encoding type and assignment strategy. In embodiments where the AP assigns function(s) and/or parameters to the STA to generate the peAIDs locally, the AID transmission component 555 includes the function(s) and/or parameters, validity period, and input datatype into the assignment frame.

In one embodiment, the AID assignment communication component 560 manages communications between the network device 500 and the STAs. More specifically, the AID assignment communication component 560 monitors STA responses to verify successful reception and storage of assigned peAIDs, function(s), and/or parameters. When errors are detected in reception and application, such as incorrect storage or transmission timing issues, the AID assignment communication component 560 manages retransmission of AID assignment frames when needed.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
establishing a wireless communications link between an access point and a wireless station, wherein establishing the wireless communications link comprises assigning the wireless station to an Enhanced Data Privacy (EDP) group, the EDP group associated with timing information for rotating wireless frame anonymization parameters at epoch transitions;
determining a privacy-enhanced association identifier (peAID) corresponding to the pairing of the access point and the wireless station, wherein a size of the peAID is greater than a size of an AID field that is used in one or more types of wireless frames on the wireless communications link;
generating an over-the-air AID (otaAID) to be used in the one or more types of wireless frames, wherein generating the otaAID comprises applying at least the peAID to a hash function; and
transmitting, from the access point, a first wireless frame having the otaAID in the AID field.

2. The method of claim 1, further comprising:
after the elapse of N epochs:
updating a value of the peAID corresponding to the pairing of the access point and the wireless station;
updating a value of the otaAID, wherein updating the value of the otaAID comprises applying at least the updated value of the peAID to the hash function; and
transmitting, from the access point, a second wireless frame having the updated value of the otaAID in the AID field.

3. The method of claim 2, further comprising:
for each epoch of the N epochs:
applying a respective salt value to the hash function; and
generating a respective value of the otaAID.

4. The method of claim 1, further comprising:
transmitting, to the wireless station, an AID assignment frame including the peAID.

5. The method of claim 1, wherein determining the peAID comprises:
applying, to a predetermined algorithm shared by the wireless station, one or more values used when establishing the wireless communications link.

6. The method of claim 5,
wherein the predetermined algorithm comprises a pseudorandom function, and
wherein the one or more values include one or more of: a media access control (MAC) address of the wireless station, a MAC address of the access point, an Authenticator Nonce generated by the access point, and a Supplicant Nonce generated by the wireless station.

7. The method of claim 1, further comprising:
transmitting, to the wireless station, a collision warning message indicating a collision or potential collision of the otaAID with a second otaAID of another wireless station,
wherein the collision warning message includes one of: an updated value of the peAID, and an updated parameter for the hash function.

8. An access point comprising:
one or more processors; and
memory configured to store computer-readable program code which, when executed by any combination of the one or more processors, performs an operation comprising:
establishing a wireless communications link with a wireless station, wherein establishing the wireless communications link comprises assigning the wireless station to an Enhanced Data Privacy (EDP) group, the EDP group associated with timing information for rotating wireless frame anonymization parameters at epoch transitions;
determining a privacy-enhanced association identifier (peAID) corresponding to the pairing of the access point and the wireless station, wherein a size of the peAID is greater than a size of an AID field that is used in one or more types of wireless frames on the wireless communications link;
generating an over-the-air AID (otaAID) to be used in the one or more types of wireless frames, wherein generating the otaAID comprises applying at least the peAID to a hash function; and
transmitting a first wireless frame having the otaAID in the AID field.

9. The access point of claim 8, the operation further comprising:
after the elapse of N epochs:
updating a value of the peAID corresponding to the pairing of the access point and the wireless station;
updating a value of the otaAID, wherein updating the value of the otaAID comprises applying at least the updated value of the peAID to the hash function; and
transmitting, from the access point, a second wireless frame having the updated value of the otaAID in the AID field.

10. The access point of claim 9, the operation further comprising:
for each epoch of the N epochs:
applying a respective salt value to the hash function; and
generating a respective value of the otaAID.

11. The access point of claim 8, the operation further comprising:
transmitting, to the wireless station, an AID assignment frame including the peAID.

12. The access point of claim 8, wherein determining the peAID comprises:
applying, to a predetermined algorithm shared by the wireless station, one or more values used when establishing the wireless communications link.

13. The access point of claim 12,
wherein the predetermined algorithm comprises a pseudorandom function, and
wherein the one or more values include one or more of: a media access control (MAC) address of the wireless station, a MAC address of the access point, an Authenticator Nonce generated by the access point, and a Supplicant Nonce generated by the wireless station.

14. The access point of claim 8, the operation further comprising:
transmitting, to the wireless station, a collision warning message indicating a collision or potential collision of the otaAID with a second otaAID of another wireless station,
wherein the collision warning message includes one of: an updated value of the peAID, and an updated parameter for the hash function.

15. A method for use with a wireless station, the method comprising:
establishing a wireless communications link with an access point, wherein the wireless station is assigned to an Enhanced Data Privacy (EDP) group, the EDP group associated with timing information for rotating wireless frame anonymization parameters at epoch transitions;
determining a privacy-enhanced association identifier (peAID) corresponding to the pairing of the access point and the wireless station, wherein a size of the peAID is greater than a size of an AID field that is used in one or more types of wireless frames on the wireless communications link;
generating an over-the-air AID (otaAID) to be used in the one or more types of wireless frames, wherein generating the otaAID comprises applying at least the peAID to a hash function;
receiving a first wireless frame from the access point; and
determining whether the first wireless frame is intended for the wireless station, wherein determining whether the first wireless frame is intended for the wireless station comprises:
applying a value of the AID field of the first wireless frame to the hash function; and
determining whether the result of applying the value of the AID field matches the peAID.

16. The method of claim 15, wherein determining the peAID comprises:
receiving, from the access point, an AID assignment frame including the peAID.

17. The method of claim 15, wherein determining the peAID comprises:
applying, to a predetermined algorithm shared by the access point, one or more values used when establishing the wireless communications link.

18. The method of claim 15, further comprising:
after the elapse of N epochs:
receiving, from the access point, a second wireless frame having an updated value of the otaAID in the AID field.

19. The method of claim 18, further comprising:
for each epoch of the N epochs:
applying a respective salt value to the hash function; and
generating a respective value of the otaAID.

20. The method of claim 15, further comprising:
receiving, from the access point, a collision warning message indicating a collision or potential collision of the otaAID with a second otaAID of another wireless station,
wherein the collision warning message includes one of: an updated value of the peAID, and an updated parameter for the hash function.
